(19) United States
(12) Patent Application Publication
(10) Pub. No.: US 2006/0152080 A1
(43) Pub. Date: Jul. 13, 2006

(54) Protection method in a vehicle brake system having electric brakes

(75) Inventors: Philippe Chico, Boulogne Billancourt (FR); Pierre Girod, Paris (FR)

Correspondence Address: SUGHRUE MION, PLLC, 2100 PENNSYLVANIA AVENUE, N.W., SUITE 800, WASHINGTON, DC, 20037, US

(73) Assignee: MESSIER-BUGATTI

(21) Appl. No.: 11/117,353

(22) Filed: Apr. 29, 2005

(30) Foreign Application Priority Data
Jan. 11, 2005 (FR) 05 00260

(51) Int. Cl. B60T 17/16

(52) U.S. Cl. 303/191; 303/89; 188/265

(57) ABSTRACT

The invention relates to a protection method for protecting from overheating in a vehicle brake system comprising at least one brake provided with at least one electromechanical actuator which comprises a pusher actuated by an electric motor to apply a force selectively onto friction elements of the brake, it being possible for the brake system to operate, at the request of the pilot of the vehicle, either in a controlled mode in which the pusher of the actuator is actuated by the electric motor so as to apply a braking force selectively to the friction elements in response to a braking instruction, or in a parking mode in which the pusher of the actuator is locked in a position in which it exerts a parking force on the friction elements. According to the invention, the method includes the step of acting, while the vehicle is at a standstill, while the brake system is in the controlled mode, and while the pusher is controlled to apply a force on the friction element, to switch automatically and without intervention from the pilot from the controlled mode to the parking mode.

The invention relates to a protection method in a vehicle brake system having electric brakes.

### BACKGROUND OF THE INVENTION

Aircraft brake systems are known that comprise brakes provided with electromechanical actuators, each of which comprises a pusher actuated by an electric motor to apply a force selectively onto friction elements of the brake.

Such a brake system can be placed in a controlled mode in which the pushers of the actuators are actuated by the associated electric motors to apply a braking force on the friction elements in response to a braking instruction, which braking instruction is determined as a function of signals coming from the pedals actuated by the pilot, or else as a function of a programmed deceleration.

The brake system can also be placed in a parking mode in which the pushers of the actuators are locked in a position in which they exert a parking force on the friction elements. The parking force is thus maintained in the absence of drive from the electric motors, which makes it possible to keep the aircraft stationary in particular when it is at a standstill and its power supply is switched off.

Under normal operating conditions, the brake system is in the controlled operating mode. The pilot causes the brake system to switch over to parking mode when said pilot wishes to keep the aircraft stationary when it is parked and before shutting down the engines of the aircraft.

Other situations exist in which the aircraft is at a standstill and held stationary, e.g. when it is waiting to taxi onto the runway (sometimes for several minutes) or else during engine run-up while the pilot runs up the engines of the aircraft while keeping the feet on the brake pedals to prevent the aircraft from moving.

During such stationary stages, the pilot presses continuously on the pedals so that the brakes are controlled to exert a continuous force. The electric motors of the actuators then run the risk of overheating dangerously. It is important for the temperature of the electric motors not to exceed a transition temperature of the resin that impregnates the coils of the electric motors.

It should be noted that that problem does not arise for conventional hydraulic brakes because no overheating is to be feared due to prolonged pressing on the pedals while the aircraft is held stationary.

### OBJECT OF THE INVENTION

An object of the invention is to provide a method of protecting the electric motors equipping the electric brakes that reduces the risk of the electric motors overheating.

### BRIEF DESCRIPTION OF THE INVENTION

The invention provides a protection method in a vehicle brake system comprising at least one brake provided with at least one electromechanical actuator which comprises a pusher actuated by an electric motor to apply a force selectively onto friction elements of the brake, it being possible for the brake system to operate, at the request of the pilot of the vehicle, either in a controlled mode in which the pusher of the actuator is actuated by the electric motor so as to apply a braking force selectively to the friction elements in response to a braking instruction, or in a parking mode in which the pusher of the actuator is locked in a position in which it exerts a parking force on the friction elements in the absence of drive from the motor, said method including the step of acting, while the vehicle is at a standstill, while the brake system is in the controlled mode, and while the pusher is controlled to apply a force on the friction element, to switch automatically and without intervention from the pilot from the controlled mode to the parking mode.

Thus, when the brake system detects a situation in which the vehicle is at a standstill and when the pilot maintains a force on the brakes, the system switches over, in accordance with the invention, to parking mode which makes it possible to maintain a parking force suitable for holding the vehicle stationary, while also relieving the electric motors, which avoids unnecessary overheating of the electric motors. In addition, the electricity consumption of the brakes is thus reduced.

Switch-over from controlled mode to parking mode automatically, in preference to the pilot ordering such a switch-over from controlled mode to parking mode, makes it possible to mitigate the risks of the pilot forgetting or acting too late, which would allow the motors enough time to overheat dangerously.

Preferably, switch-over from the controlled mode to the parking mode takes place only after a predetermined delay.

Advantageously, switch-over from the controlled mode to the parking mode takes place in response to an overheating signal indicating that a temperature threshold has been exceeded in the electric motor of the actuator.

In a particular aspect of the invention, switch-over from the controlled mode to the parking mode is possible only if the braking instruction exceeds a first predetermined force threshold.

Preferably, switching back from the parking mode to the controlled mode then takes place if the braking instruction drops below a second predetermined force threshold that is lower than the first force threshold.

In another particular aspect of the invention, witching back from the parking mode to the controlled ode takes place in response to a signal indicating that the aircraft is no longer at a standstill.

### BRIEF DESCRIPTION OF THE DRAWINGS

The invention will be better understood on reading the following description given with reference to the accompanying drawings, in which:

FIG. 1 is a diagrammatic view of an aircraft having a plurality of braked wheels;

FIG. 2 is a view in section through one of the wheels of the FIG. 1 aircraft that is equipped with a brake having electrical actuators;

FIG. 3 is a diagram of the logic circuit used for switching over from the controlled mode to the parking mode; and

FIG. 4 is a diagram of how an overheating signal is generated making it possible to accelerate switch-over to parking mode.

### DETAILED DESCRIPTION OF THE INVENTION

The method of the invention is described in detail below as used in an aircraft A such as the aircraft shown in FIG. 1 which has four braked wheels numbered 1 to 4, carried by undercarriages 15.

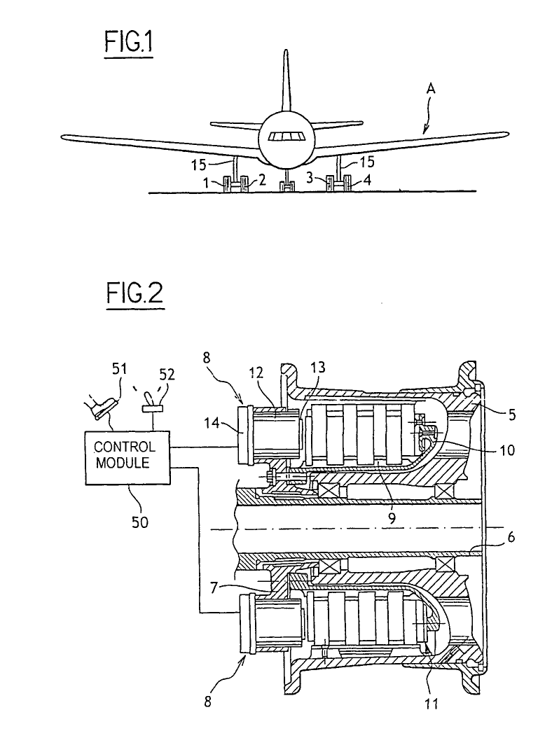

As shown in FIG. 2, each of the wheels comprises a rim 5 adapted to receive a tire (not shown) and mounted to rotate on an axle 6 carried by one of the undercarriages 15 of the aircraft. A ring 7 carrying electromechanical actuators 8 is mounted on the axle 6.

A torsion tube 9 that extends inside the rim 5 and that is terminated by an abutment 10 is fastened to the ring 7. The ring 7, and thus the torsion tube 9, are held in rotation relative to the axle 6 by stop means (not shown).

A stack of disks 11 made up of rotors that are constrained in rotation with the rim 5, and of stators that are constrained in rotation with the torsion tube 9 extends between the abutment 10 and the actuators 8.

Each of the actuators 8 comprises a body 12 in which a pusher 13 is mounted to move linearly facing the stack of disks 11 under drive from an electric motor contained inside the body 12, in order to apply to the stack of disks 11 a controlled pressure force which, by inducing friction forces between the rotors and the stators in the stack of disks, contributes to slowing down rotation of the rim 5, and thus to braking the aircraft.

Each of the actuators 8 has a locking member 14 adapted to lock the pusher 13 in the position in which it is situated at the time the locking member 14 is activated.

The actuators are associated with a control module 50 which, in this example, has two operating modes, firstly a controlled mode in which the pushers 13 are moved against the stack of disks 11 by an electric motor in response to a braking force instruction which is generated in particular from signals coming from the brake pedals 51 actuated by the pilot, and secondly a parking mode in which the pusher 13 is controlled to exert a parking force on the stack of disks 11, and then locked in position by the locking member 14.

The parking force is thus maintained without the assistance of the electric motor, and the electrical power supply thereto can be switched off, thereby reducing the electricity consumption of the brakes and preventing the electric motors from overheating.

A selector 52 having two positions is at the disposal of the pilot, and, by using it, the pilot can place the brake system either in the controlled mode, or in the parking mode.

The method of the invention is more particularly applicable to situations in which the brake system is in the controlled mode, and the aircraft is at a standstill. In which case, in order to keep the aircraft stationary, the pilot presses continuously on the brake pedals 51 so that the electric motors of the actuators 8 are continuously operated and might overheat.

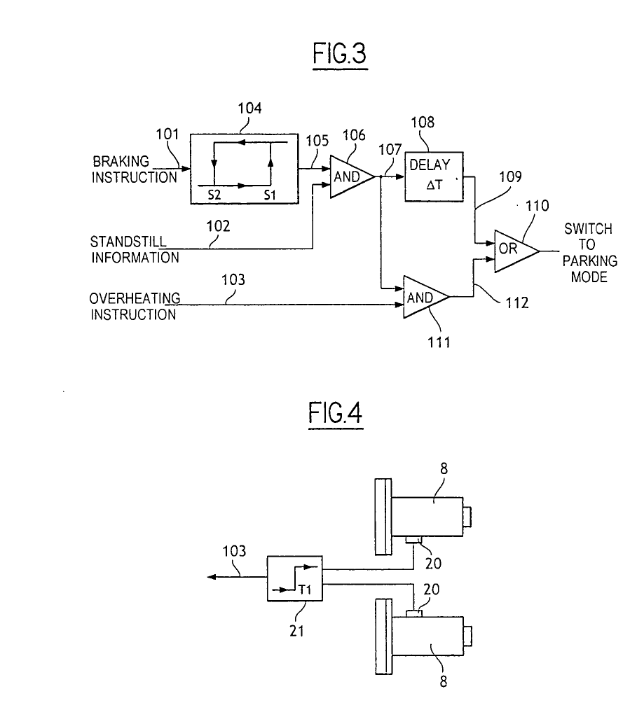

In the invention, the brake system is also configured to switch over automatically to parking mode, using the logic circuit shown in FIG. 3.

In the particular implementation of the method of the invention that is shown, the logic circuit for automatically switching over to parking mode uses three inputs:

a first input constituted by the braking force instruction 101;

a second input constituted by standstill information 102 generated by one of the computers of the aircraft and indicating that the aircraft is at a standstill; and

a third input constituted by an overheating signal 103 indicating that the electric motors of the actuators are overheating.

How the inputs are generated is described in detail further on below.

The braking instruction is processed by a two- threshold comparator 104. The output 105 of the comparator 104 goes to 1 if the braking force instruction 101 increases beyond a first force threshold Si, and remains at 1 so long as the braking instruction 101 does not decrease below a second force threshold S2 that is lower than the first force threshold Si.

The output 105 of the comparator 104 and the standstill information 102 form the inputs for a first AND gate 106. The AND gate 106 has an output 107 which is connected via a time delay circuit 108 to form a first input 109 of an OR gate 110. The output of the OR gate 110 constitutes a switch-to-parking-mode signal for the brake system.

In addition, the overheating signal 103 and the output 107 of the first AND gate 106 form the inputs of a second AND gate 111 whose output 112 forms the second input of the OR gate 110.

The logic circuit operates as follows. While the aircraft is at a standstill, as is indicated by the standstill information 102, the pilot keeps the aircraft stationary by pressing on the brake pedals 51. If the braking instruction generated by the control module as a function of the pressure on the pedals exceeds the first force threshold S1, then the output 105 of the comparator goes to 1, which also causes the output of the first AND gate 107 to go to 1. After a time delay ΔT set by the time delay circuit 108, the output of the time delay circuit 108 which forms the first input 109 of the OR gate 110 goes to 1, so that the OR gate 110 delivers a signal to the brake system instructing it to switch to parking mode.

However, if, before the end of the delay ΔT, the overheating signal 103 goes to 1, then the output of the AND gate 111 that forms the second input 112 of the OR gate 110 goes to 1. The OR gate 110 then delivers a signal to the brake system to instruct it to switch to parking mode.

In order to return to the controlled mode, it suffices for the braking force instruction 101 to decrease below the second force threshold S2, thereby indicating that the pilot intends to release the brakes of the aircraft. The output 105 of the comparator 104 goes to 0, thereby causing the output 107 of the first AND gate 106 to go to 0, and thereby setting the two inputs 109 and 112 of the OR gate 110 to zero. The OR gate 110 ceases to deliver the switch-to-parking-mode signal, and the brake system returns to controlled mode.

In practice, the first force threshold S1 is chosen to be high enough to ensure that the brake system does not incessantly switch over from the controlled mode to the parking mode. Preferably, the first force threshold Si corresponds to a threshold for the current powering the electric motor of the actuator, beyond which the electric motor might overheat if the braking force instruction remains above the first force threshold S1 for a time is longer than the time delay ΔT.

As regards the second force threshold S2, it is chosen so that the brake system remains in the parking mode even in the event that the pilot “pumps” the brake 51.

The purpose of the time delay is to avoid switching over to parking mode when the brake pedals 51 are pressed briefly. In practice, the time delay ΔT of the time delay circuit is of the order of a few seconds.

The braking force instruction 101 is generated by the control module 50 on the basis of the signals coming from the brake pedals 51. In a degraded mode, it can also be constituted directly by the signal from the brake pedals 51.

The standstill information 102 is generated by a computer of the aircraft on the basis of information indicating the speed of the aircraft, or else on the basis of information coming from a sensor sensing rotation of any one of the wheels of the aircraft.

The overheating signal 103 can be generated in various ways.

In a first mode of generation shown in FIG. 4, said signal can come from temperature probes 20 installed in the electric motors of the actuators 8, said probes being connected to a comparator 21 so that, when one of them measures a temperature greater than a given threshold Ti, the output of the comparator 21 that forms the overheating signal 103 goes to 1.

Rather than measuring the temperature directly by means of temperature probes, it is also possible to measure the resistance of the coil of each electric motor, since said resistance varies with the temperature of the electric motor.

In a second mode of generation, for each electric motor, an energy accumulation signal is generated by integrating the power supply current to said electric motor over time. The energy accumulation signal calculated in this way represents the energy delivered to the electric motor, and thus the risk of said electric motor overheating.

The overheating signal 103 then forms the output of a comparator which receives as input all of the energy accumulation signals, said output going to 1 if one of the energy accumulation signals exceeds a predetermined threshold.

The invention is not limited to what is described above, but rather, it encompasses any variant lying within the ambit defined by the claims.

In particular, although it is indicated above that the braking instruction is a force instruction, said instruction may take any other form such as, for example, an instruction for a position that is representative of a force.

What is claimed is:

1. A protection method in a vehicle brake system comprising at least one brake provided with at least one electromechanical actuator which comprises a pusher actuated by an electric motor to apply a force selectively onto friction elements of the brake, it being possible for the brake system to operate, at the request of the pilot of the vehicle, either in a controlled mode in which the pusher of the actuator is actuated by the electric motor so as to apply a braking force selectively to the friction elements in response to a braking instruction, or in a parking mode in which the pusher of the actuator is locked in a position in which it exerts a parking force on the friction elements in the absence of drive from the motor, said method including the step of acting, while the vehicle is at a standstill, while the brake system is in the controlled mode, and while the pusher is controlled to apply a force on the friction element, to switch automatically and without intervention from the pilot from the controlled mode to the parking mode.

2. A method according to claim 1, wherein switch-over from the controlled mode to the parking mode takes place only after a predetermined delay.

3. A method according to claim 1, wherein switch-over from the controlled mode to the parking mode takes place in response to an overheating signal indicating that a temperature threshold has been exceeded in the electric motor of the actuator.

4. A method according to claim 1, wherein switch-over from the controlled mode to the parking mode is possible only if the braking instruction exceeds a first predetermined force threshold.

5. A method according to claim 4, wherein switching back from the parking mode to the controlled mode takes place if the braking instruction descends below a second predetermined force threshold that is lower than the first force threshold.

6. A method according to claim 1, wherein switching back from the parking mode to the controlled mode takes place in response to a signal indicating that the aircraft is no longer at a standstill.
